(19) United States
(12) Patent Application Publication
(10) Pub. No.: US 2022/0189688 A1
(43) Pub. Date: Jun. 16, 2022

(54) Preparation method for a neodymium-iron-boron magnet

(71) Applicant: Yantai Dongxing Magnetic Materials Inc., Yantai (CN)

(72) Inventors: Xiaonan ZHU, Yantai (CN); Zhongjie PENG, Yantai (CN); Chunjie XIANG, Yantai (CN); Qiang ZHANG, Yantai (CN); Kaihong DING, Yantai (CN)

(21) Appl. No.: 17/551,284

(22) Filed: Dec. 15, 2021

(30) Foreign Application Priority Data
Dec. 15, 2020 (CN) 202011473669.4

(51) Int. Cl. H01F 41/02; H01F 1/057; B22F 9/04; B22F 3/16; B22F 3/24; C22C 38/16; C22C 38/10; C22C 38/06; C22C 38/00; C22C 38/14

(52) U.S. Cl. CPC H01F 41/0266; B22F 2304/10; B22F 9/04; B22F 3/16; B22F 3/24; C22C 38/16; C22C 38/10; C22C 38/06; C22C 38/005; C22C 38/002; C22C 38/14; B22F 2009/044; B22F 2202/05; B22F 2003/248; B22F 2301/45; B22F 2301/355; C22C 2202/02; H01F 1/057

(57) ABSTRACT

The disclosure refers to a preparation method for NdFeB permanent magnet including:

a) Preparing main alloy flakes consisting of (Pr₂Nd₈)ₓFe_{100-x-y-z}B_{y}M_{z},where M is at least one of Al,Co,Cu,Ga,Ti and Zr, 28.5 wt. % ≤x≤31.0 wt. %,0.85 wt. %≤y≤0.98 wt. % and 0.5 wt. %≤z≤5.0 wt. %;

b) Preparing auxiliary alloy flakes consisting of LᵤFe_{100-u-v-w}BᵥM_{w},where L is at least one ofPr and Nd,M is at least one of Al,Co,Cu,Ga,Ti and Zr, 35.0 wt. %≤u≤45.0 wt. %,0 wt. %≤v≤5.0 wt. % and 2.0 wt. %≤w≤10.0 wt. %;

c) Mixing the main alloy flakes and the auxiliary alloy flakes in predetermined rate, then performing hydrogen decrepitation to produce alloy pieces,and then crushing the alloy pieces to alloy powder by jet milling;

d) Preparing a powder mixture including the alloy powder and added heavy rare earth powder consisting of at least one of Dy and Tb;

e) Pressing the powder mixture to a green compact while applying a magnetic field, and thermal treatment of the green compact in a vacuum furnace to obtain the NdFeB permanent magnet.

### CROSS-REFERENCE TO RELATED APPLICATIONS

This application is based on Chinese Patent Application No. 202011473669.4, filed Dec. 15, 2020, which claims the benefit of priority to the Chinese Patent Application, which is incorporated by reference in its entirety herein.

### BACKGROUND OF THE DISCLOSURE

### Field of the Disclosure

The present disclosure relates to a method for preparing magnetic materials, in particular for preparing a sintered NdFeB magnets.

### Description of the Prior Art

Permanent magnet materials are the most widely used, and rare earth permanent magnet is an important part of permanent magnet materials, especially the third generation of rare earth permanent magnet NdFeB permanent magnet material has been widely used with its excellent magnetic properties.

With the further expansion of application fields, higher requirements are put forward for the performance of NdFeB permanent magnet materials. In order to meet the requirements of operating temperature in applications such as motors and generators, it is necessary to increase the maximum operating temperature of sintered NdFeB. The main ways include increasing the Curie temperature, coercivity and magnetocrystalline anisotropy field. Studies, have shown that adding, heavy rare earth elements, such as Dy and Tb, to the magnet is the most effective means to improve the magnet's working temperature and coercivity. Due to the low reserves and high price of heavy rare earth elements, the addition increases the cost of the magnet. At the same time, due to the anti-ferromagnetic coupling between heavy rare earth and iron, the heavy rare earth Dy and Tb element was entered into the main phase by smelting alloy, and reduced the remanence of the magnet.

How to increase the coercivity of the magnet without reducing the remanence and the low content of heavy rare earths has become an urgent problem in the development of neodymium iron boron permanent magnets.

At present, the most effective way to increase the coercivity is to improve the grain boundaries and diffuse low amount of Dy and Tb into the main phase. The clear continuous grain boundary phase inhibits the nucleation of anti-magnetization domains and improves the coercivity while avoiding the decline of remanence. Due to the limitation of the diffusion depth of grain boundary, it is only suitable for magnets with thickness less than 5 mm. In addition, the low utilization rate of heavy rare earth will also increase the production cost. Patent number ZL201110242847.7 invented a preparation method of low Dy content and high performance sintered NdFeB. The Dy element is introduced into the particle surface of powder by sputtering deposition method that Dy element is difficult to accurately control. Patent number CN109102976 invented a method to improve the performance of rare earth magnet, with heavy rare earth alloy adding into the main grain boundary and the heavy rare earth distributing to the main phase boundary. It is not only reducing the milling efficiency and increasing the risk of nitride and oxide, but also reducing the efficiency of magnet production, for the production of grain refinement process and low temperature sintering process for a long time.

### SUMMARY OF DISCLOSURE

The present disclosure provides a preparation method for a NdFeB permanent magnet as defined in claim 1. The method includes the steps of:

a) Preparing main alloy flakes consisting of (Pr₂Nd₈)ₓFe_{100-x-y-z}B_{y}M_{z},where M is at least one of Al,Co,Cu,Ga,Ti and Zr,and x,y and z is 28.5 wt. %≤x≤31.0 wt. %,0.85 wt. %≤y≤0.98 wt. % and 0.5 wt. %≤z≤5.0 wt. %;

b) Preparing auxiliary alloy flakes consisting of LᵤFe_{100-u-v-w}BᵥM_{w},where L is one or more of the metals Pr and Nd, M is at least one of Al,Co,Cu,Ga,Ti and Zr,and u,v and w is 35.0 wt. %≤u≤u≤45.0 wt. %,0 wt. %≤v≤5.0 wt. % and 2.0 wt. %≤w≤10.0 wt. %;

c) Mixing the main alloy flakes and the auxiliary alloy flakes in a predetermined rate,then performing a hydrogen decrepitation to produce alloy pieces,and then crushing the alloy pieces to an alloy powder by jet milling;

d) Preparing a powder mixture including the alloy powder and an added heavy rare earth powder consisting of at least one of Dy and Tb; and

e) Pressing the powder mixture to a green compact while applying a magnetic field,and thermal treatment of the green compact in a vacuum furnace to obtain the NdFeB permanent magnet.

According to one embodiment, the auxiliary alloy may include Pr and Nd. In particular, a content ratio of Pr to Nd may be in the range of 0.25 to 1.

According to another embodiment, which could be combined with the before mentioned embodiment, the auxiliary alloy flakes are added in proportion of 5 wt % to 20 wt % in step c).

According to another embodiment, which could be combined with one or more of the before mentioned embodiments, the heavy rare earth powder, which is added in step d), has an average particle size D50 in the range of 1.0 μm-3.0 μm, the mass percentage of the heavy rare earth is in the range of 0.05%-1.0%, and the powder are mixed about 90-150 min.

According to another embodiment, which could be combined with one or more of the before mentioned embodiments, the thermal treatment of step e) includes a sub-step of sintering the green compact at a temperature in the range of 850° C. to 950° C. for 2 to 5 hours, and then heating to 1030° C. to1090° C. for 4 to 8 h. Furthermore, the thermal treatment of step e) may further include the sub-steps of cooling the sintered green compact, and then annealing the sintered compact at a temperature in the range of 800° C. to 900° C. for 2 to 4 hours and then at a temperature in the range of 450° C. to 550° C. for 3 to 6 hours.

It has been found by the inventors that a low melting point alloy containing no heavy rare earth could be used to transport heavy rare earth powder around the main phase. The auxiliary phase facilitates the diffusion of heavy rare earths into the main phase during the sintering process, promotes the formation of a high H_{A} phase shell layer in the main phase, and improves the coercivity.

The invention adopts the principle of diffusion, adding heavy rare earth powder (containing or consisting of Dy and/or Tb) to a NdFeB alloy containing a low melting point auxiliary phase alloy. The heavy rare earth powder is evenly dispersed around the main phase in the sintering process.

The sintering process may be divided in two sub-steps of first holding the temperature for 2 to 5 h at 850° C. to 950° C. and then sintering at a higher temperature. Under the higher temperature, the heavy rare earth metals Dy or Tb will diffuse into the magnet and enter the surface layer of the main phase particles, forming a DyFeB or TbFeB with high H_{A}. The auxiliary alloy is easy to form the grain boundary phase with uniform continuous distribution, which will increase the coercivity during the annealing process.

### DETAILED DESCRIPTION OF THE DISCLOSURE

The following disclosure provides a preparation method for a sintered NdFeB magnet having of high remanence and high coercivity by adding a low amount of a heavy rare earth metal.

Only a low amount of a heavy rare earth powder (Dy and/or Tb) is added during the preparation of the sintered NdFeB magnet. A low melting alloy without heavy rare earth metals is added for forming the grain boundary phase and then the heavy rare earth powder with a mass percentage in the range of 0.05 wt % to 1.0 wt % based on the total weight of the composition. According to an embodiment, the method includes the following steps:

a) Main alloy flakes are provided. The composition of the main alloy flakes is set to (Pr₂Ndₛ)ₓFe_{100-x-y-z}B_{y}M_{z}, where M is at least one of Al, Co, Cu, Ga, Ti and Zr, and x, y and z is 28.5 wt. %≤x≤31.0 wt. %, 0.85 wt. %≤y≤0.98 wt. % and 0.5 wt. %≤z≤05.0 wt. %. The main alloy flakes do not contain a-Fe and the elements Dy or Tb.

b) Further, auxiliary alloy flakes are provided. The composition of the auxiliary alloy flakes can be set to LᵤFe_{100-u-v-w}BᵥM_{w}, where L is one or more of the metals Pr and Nd, M is at least one of Al, Co, Cu, Ga, Ti and Zr, and u, v and w is 35.0 wt. %≤u≤45.0 wt. %, 0 wt. %≤v≤5.0 wt. % and 2.0 wt. % ≤v≤10.0 wt. %.

c) The main alloy flakes and the auxiliary alloy flakes are mixed in an appropriate rate and then a hydrogen decrepitation is performed to produce smaller alloy pieces. The alloy pieces are pulverized to an alloy powder by jet milling.

d) A powder of the heavy rare earth elements Dy or Tb is added to the jet milled alloy powder of step c). The amount of the added heavy rare earth powder is in the range of 0.05 wt % to 1.0 wt % and the resulting powder mixture is mixed to uniformity using a mixer equipment.

e) The final alloy powder obtained by step d) is pressed to a green compact while applying a magnetic field. The green compact is pit into a vacuum furnace for thermal treatment, i.e. sintering and annealing the green compact to a sintered NdFeB magnet.

In step b), when Pr and Nd metal are both selected as a rare earth element L in the auxiliary alloy, the content ratio of Pr and Nd is 0.25 to 1. In other words, the auxiliary alloy may then include 4 times as much Pr than Nd (by weight) to equal amounts of Pr and Nd, but no excess of Nd.

The main alloy flakes and the auxiliary alloy flakes are mixed in step c). The resulting mixture shall include 5 wt % to 20 wt % of the auxiliary alloy flakes, i.e. the main alloy flakes represent 80 wt % to 95 wt % of said mixture.

In step d) a heavy rare earth powder is added, especially a Dy or Tb powder. An average particle size D50 of the heavy rare earth powder may be in the range 1.0 μm to 3.0 μm. The average particle diameter of the particles may be for example measured by a laser diffraction device using appropriate particle size standards. Specifically, the laser diffraction device is used to determine the particle diameter distribution of the particles, and this particle distribution is used to calculate the arithmetic average of particle diameters. More precisely, the particle size of a non-spherical particle may be determined by a dynamic light-scattering measurement method. Specifically, the size may be measured by ISO 13320 through the analysis of the light-scattering properties of the particles,

Further, a mass percentage of the added heavy rare earth powder may be in the range of 0.05 wt. % to 1.0 wt. %. The powders may be mixed about 90 to 150 min to obtain a final alloy powder.

In step e), the final alloy powder is pressed to a green compact while applying a magnetic field of 1.8 to 2.57. The green compact is put into a vacuum furnace to perform a sintering and annealing process. During the sintering process, the temperature is in the range of 850° C. to 950° C. for 2 to 5 hours and then raised to 1030° C. to1090° C. for 4 to 8 h. After cooling, the annealing process follows. The sintered green compact is first heated to a temperature in the range of 800° C. to 900° C. for 2 to 4 hours, and then the temperature is set to be in the range, of 450° C. to 500° C. for 3 to 6 hours.

The following technical advantages may result by performing the preparation process as described above:

The disclosure adopts the principle of diffusion for reference, adding heavy rare earth Dy or Tb powder to NdFeB alloy containing low melting point auxiliary phase alloy,

The heavy rare earth elements are carried by the auxiliary alloy having a lower melting point and evenly dispersed around the main phase in the sintering process. The Dy or Tb will diffuse into the magnet and enter the surface layer of the main phase particles, forming DyFeB or TbFeB phases with high H_{A}. The coercivity is significantly improved while the remanence is not or only slightly reduced. The preparation process of magnets may be performed with reduced energy consumption and improved production efficiency compared to congenital processes.

In other words, a low melting auxiliary alloy without heavy rare earth content and a small amount of heavy rare earth Dy or Tb powders is added to the main alloy powder. The grain boundary phase formed by the auxiliary alloy having a lower melting point than the main alloy forms a high-fluidity phase carrying the heavy rare earth Dy or Tb distribution around the main phase of the main alloy. In the process of sintering, the heavy rare earth Dy or Tb powders diffuse into the surface of the main phase to realize the introduction of heavy rare earth elements. The auxiliary alloy is easy to form the grain boundary phase with uniform and continuous distribution, which will improve the coercivity during the annealing process.

This method can be widely used in the preparation and production of low weight rare earth high performance sintered NdFeB.

### IMPLEMENTING EXAMPLE 1

The main alloy composition is (Pr₂Nd₈)₃₀Fe_{bal}B_{0.95}(CoCuAlGa)₂ and the auxiliary alloy composition is (Pr₂Nd₈)₄₀Fe_{bal}B_{0.3}(CoCuAlGaTi)₃ and the alloy flakes are obtained by a convectional strip casting process. The main alloy flakes and the auxiliary alloy flakes are mixed in proportion ratio of 9 to 1. The mixed flakes are put into a hydrogen treatment furnace for conventional hydrogen absorption and dehydrogenation. The obtained alloy pieces are mixed with an antioxidant and a lubricant, and is crushed into a powder by jet milling, wherein the powder has an average particle size D50 of 3.8 μm. A Dy powder having an average the particle size of 1.5 μm is added to the milled powder with a mass percentage rate of 0.5 wt % and the composition is mixed uniformly in a three-dimensional mixing machine for about 90 to 150 min. The mixed powder is pressed to a green compact while applying a magnetic field of 2.0 T. The green compact is put into a vacuum furnace to perform a thermal treatment including a sintering step and an annealing step. The sintering step is performed at 1050° C. for 6 hours. The annealing step is perfomed at 850° C. for 3 hours, and then the temperature is reduced to 500° C. for 3 hours.

### IMPLEMENTING EXAMPLE 2

The preparation conditions are the same as in Implementing Example 1 except that the main alloy composition is (Pr₂Nd₈)₃₀Fe_{bal}B_{0.95}(CoCuAlGa)₂ and the auxiliary alloy composition is (Pr₂Nd₈)₄₀Fe_{bal}(CoCuAlGaTi)₃.

### IMPLEMENTING EXAMPLE 3

The preparation conditions are the same as in Implementing Example 1 except that the main alloy composition is (Pr₂Nd₈)₃₀Fe_{bal}B_{0.95}(CoCuAlGa)₂ and the auxiliary alloy composition is (Pr₂Nd₈)₄₀Fe_{bal}B_{0.3}(CoCuAlGaTi)₃. Further, the Dy powder is added with an amount of 1.0 wt. %

### IMPLEMENTING EXAMPLE 4

The preparation conditions are the same as in Implementing Example 1 except that the main alloy composition is (Pr₂Nd₈)₃₀Fe_{bal}B_{0.95}(CoCuAlGa)₂ and the auxiliary alloy composition is (Pr₂Nd₈)₄₀Fe_{bal}B_{0.3}(CoCuAlGaTi)₃. Further, 0.5 wt. % of a Tb powder with an average particle size of 1.0 μm instead of the Dy powder is added.

### IMPLEMENTING EXAMPLE 5

The preparation conditions are the same as in Implementing Example 1 except that the main alloy composition is (Pr₂Nd₈)₃₀Fe_{bal}B_{0.95}(CoCuAlGa)₂ and the auxiliary alloy composition is Pr₄₀Fe_{bal}B_{0.3}(CoCuAlGaTi)₃.

### IMPLEMENTING EXAMPLE 6

The preparation conditions are the same as in Implementing Example 1 except that the main alloy composition is (Pr₂Nd₈)₃₀Fe_{bal}B_{0.95}(CoCuAlGa)₂ and the auxiliary alloy composition is Nd₄₀Fe_{bal}B_{0.3}(CoCuAlGaTi)₃.

### IMPLEMENTING EXAMPLE 7

The preparation conditions are the same as in Implementing Example 1 except that the main alloy composition is (Pr₂Nd₈)₃₀Fe_{bal}B_{0.95}(CoCuAlGa)₂ and the auxiliary alloy composition is (Pr₅Nd₅)₄₀Fe_{bal}B_{0.3}(CoCuAlGaTi)₃.

### COMPARATIVE EXAMPLE 1

The NdFeB alloy composition is (Pr₂Nd₈)_{30.5}Fe_{bal} B_{0.9}(CoCuAlGa)₂ and made into alloy flakes by, a strip casting process. The alloy flakes are put into a hydrogen treatment furnace for conventional hydrogen absorption and dehydrogenation. The obtained alloy pieces are mixed with an antioxidant and a lubricant, and are crushed into a powder by jet milling with an average particle size of 3.8 μm. The milled powder is pressed to a green compact while applying a magnetic field of 2.0 T. The green compact is put into a vacuum furnace to get the magnet. The sintering process is performed at 1050° C. for 6 hours, and the annealing treatment is performed at 850° C. for 3 hours, and then the temperature is reduced to 500° C. for 3 hours.

### COMPARATIVE EXAMPLE 2

The main alloy composition is (Pr₂Nd₈)₃₀Fe_{bal}B_{0.95}(CoCuAlGa)2 and the auxiliary alloy composition is (Pr₂Nd₈)₄₀Fe_{bal}B_{0.3}(CoCuAlGaTi)₃ are alloy flakes are made by a strip casting process. The main alloy flakes and the auxiliary alloy flakes are mixed in proportion ratio of 9 to 1, and the mixed flakes are put into a hydrogen treatment furnace for conventional hydrogen absorption and dehydrogenation. The obtained alloy pieces are mixed with an antioxidant and lubricant, and are crushed into a powder by jet milling with an average particle size of 3.8 μm. The mixed powders are pressed to a green compact while applying a magnetic field of 2.0 T. The green compact is put into a vacuum furnace to get the magnet. The sintering process is performed at 1050° C. for 6 hours. The annealing treatment is performed at 850° C. for 3 hours and then the temperature is reduced to 500° C. for 3 hours.

Process parameters and magnetic characteristics of Implementing Examples 1 to 7 and Comparative Examples 1 and 2 are listed in Table 1.

TABLE 1
process parameters of the examples

| | | Rare | | Adding | | |
|---|---|---|---|---|---|---|
| | B | earth | Adding | of heavy | | |
| | content of | type of | rate of | rare | | |
| | auxiliary | auxiliary | auxiliary | earth | Br | Hcj |
| | alloy | alloy | alloy | powder | (T) | (kA/m) |
| Implementing | 0.3 wt % | Pr₂Nd₈ | 10% | Dy powder: | 1.430 | 1393 |
| example 1 | | | | 0.5 wt. % | | |
| | | | | powder size: | | |
| | | | | 1.5 μm | | |
| Implementing | 0 wt % | Pr₂Nd₈ | 10% | Dy powder: | 1.433 | 1385 |
| example 2 | | | | 0.5 wt. % | | |
| | | | | powder size: | | |
| | | | | 1.5 μm | | |
| Implementing | 0.3 wt % | Pr₂Nd₈ | 10% | Dy powder: | 1.425 | 1457 |
| example 3 | | | | 1.0 wt. % | | |
| | | | | powder size: | | |
| | | | | 1.5 μm | | |
| Implementing | 0.3 wt % | Pr₂Nd₈ | 10% | Tb powder: | 1.435 | 1473 |
| example 4 | | | | 0.5 wt. % | | |
| | | | | powder size: | | |
| | | | | 1.0 μm | | |
| Implementing | 0.3 wt % | Pr | 10% | Dy powder | 1.428 | 1427 |
| example 5 | | | | 0.5 wt. % | | |
| | | | | powder size: | | |
| | | | | 1.5 μm | | |
| Implementing | 0.3 wt % | Nd | 10% | Dy powder | | |
| example 6 | | | | 0.5 wt. % | 1.433 | 1399 |
| | | | | powder size: | | |
| | | | | 1.5 μm | | |
| Implementing | 0.3 wt % | Pr₅Nd₅ | 10% | Dy powder | 1.430 | 1411 |
| example 7 | | | | 0.5 wt. % | | |
| | | | | powder size: | | |
| | | | | 1.5 μm | | |
| Comparative | No | Pr₂Nd₈ | No | 0 | 1.440 | 1114 |
| example 1 | adding | | adding | | | |
| | auxiliary | | | | | |
| | alloy | | | | | |
| Comparative | 0.3 wt % | Pr₂Nd₈ | 10% | 0 | 1.440 | 1274 |
| example 2 | | | | | | |

Compared with Comparative Example 1, the Implementing Examples 1 to 4 show improved coercivity by adding the auxiliary alloy with the rare earth elements Pr₂Nd₈.Compared with the Comparative Example 2 where no heavy rare earth powder is added, the Implementing Examples 1 to 3 show an improved magnetic coercivity. Comparing Implementing Examples 5 to 6 with Comparative Example 1, shows that adjusting the ratio of Pr and Nd of the auxiliary alloy also can improve the coercivity, especially when Pr and Nd metal are both selected, the improvement effect of coercivity is more obvious when the content of Pr increases.

The preparation method only uses a low amount of added heavy rare earth powder to improve the properties of the sintered NdFeB magnet. Due to the use of an auxiliary alloy, the formation of the grain boundary phase is improved and the heavy rare earth elements Dy or Tb are carried by the lower melting auxiliary alloy resulting in an evenly dispersion of the heavy rare earth metals around the main phase. Under the sintered temperature, the Dy or Tb will diffuse into the surface layer of the main phase, forming the desired DyFeB or TbFeB phase with high H_{A}. Thereby, the coercivity can be significantly improved and remanence kept high.

What claimed is:

1. A preparation method for NdFeB permanent magnet, the method including the steps of:
a) Preparing main alloy flakes consisting of (Pr₂Nd₈)ₓFe_{100-x-y-z}B_{y}M_{z}, where M is at least one of Al, Co, Cu, Ga,Ti and Zr, and x, y and z is 28.5 wt. %≤x≤31.0 wt. %, 0.85 wt. %≤y≤0.98 wt. % and 0.5 wt. %≤z≤5.0 wt. %;
b) Preparing auxiliary alloy flakes consisting of LᵤFe_{100-u-v-w}BᵥM_{w}, where L is one or more of the metals Pr and Nd, M is at least one of Al, Co, Cu, Ga, Ti and Zr, and u,v and w is 35.0 wt. %≤u≤45.0 wt. %, 0 wt. %≤v≤5.0 wt. % and 2.0 wt. %≤w≤10.0 wt. %;
c) Mixing the main alloy flakes and the auxiliary alloy flakes in a predetermined rate, then performing a hydrogen decrepitation to produce alloy pieces,and then crushing the alloy pieces to an alloy powder by jet milling;
d) Preparing a powder mixture including the alloy powder and an added heavy rare earth powder consisting of at least one of Dy and Tb; and
e) Pressing the powder mixture to a green compact while applying a magnetic field, and thermal treatment of the green compact in a vacuum furnace to obtain the NdFeB permanent magnet.

2. The preparation method of claim 1, wherein the auxiliary alloy includes Pr and Nd.

3. The preparation method of claim 2, wherein a content ratio of Pr to Nd is in the range of 0.25 to 1.

4. The preparation method of claim 1, wherein the auxiliary alloy flakes are added in proportion of 5 wt % to 20 wt % in step c).

5. The preparation method of claim 2, wherein the auxiliary alloy flakes are added in proportion of 5 wt % to 20 wt % in step c).

6. The preparation method of claim 3, wherein the auxiliary alloy flakes are added in proportion of 5 wt % to 20 wt % in step c).

7. The preparation method of claim 1, wherein the heavy rare earth powder, which is added in step d), has an average particle size D50 in the range of 1.0 μm-3.0 μm, the mass percentage of the heavy rare earth is in the range of 0.05%-1.0%, and the powder are mixed about 90-150 min.

8. The preparation method of claim 2, wherein the heavy rare earth powder, which is added in step d), has an average particle size D50 in the range of 1.0 μm-3.0 μm, the mass percentage of the heavy rare earth is in the range of 0.05%-1.0%, and the powder are mixed about 90-150 min.

9. The preparation method of claim 3, wherein the heavy rare earth powder, which is added in step d), has an average particle size D50 in the range of 1.0 μm-3.0 μm, the mass percentage of the heavy rare earth is in the range of 0.05%-1.0%, and the powder are mixed about 90-150 min.

10. The preparation method of claim 4, wherein the heavy rare earth powder, which is added in step d), has an average particle size D50 in the range of 1.0 μm-3.0 μm, the mass percentage of the heavy rare earth is in the range of 0.05%-1.0%, and the powder are mixed about 90-150 min.

12. The preparation method of claim 1, wherein the thermal treatment of step e) includes a sub-step of sintering the green compact at a temperature in the range of 850° C. to 950° C. for 2 to 5 hours, and then heating to 1030° C. to 1090° C. for 4 to 8 h.

13. The preparation method of claim 2, wherein the thermal treatment of step e) includes a sub-step of sintering the green compact at a temperature in the range of 850° C. to 950° C. for 2 to 5 hours, and then heating to 1030° C. to 1090° C. for 4 to 8 h.

14. The preparation method of claim 3, wherein the thermal treatment of, step e) includes a sub-step of sintering the green compact at a temperature in the range of 850° C. to 950° C. for 2 to 5 hours, and then heating to 1030° C. to 1090° C. for 4 to 8 h.

15. The preparation method of claim 4, wherein the thermal treatment of step e) includes a sub-step of sintering the green compact at a temperature in the range of 850° C. to 950° C. for 2 to 5 hours, and then heating to 1030° C. to 1090° C. for 4 to 8 h.

16. The preparation method of claim 7, wherein the thermal treatment of step e) includes a sub-step of sintering the green compact at a temperature in the range of 850° C. to 950° C. for 2 to 5 hours, and then heating to 1030° C. to 1090° C. for 4 to 8 h.

17. The preparation method of claim 12, wherein the thermal treatment of step e) further includes the sub-steps of cooling the sintered green compact, and then annealing the sintered compact at a temperature in the range of 800° C. to 900° C. for 2 to 4 hours and then at a temperature in the range of 450° C. to 550° C. for 3 to 6 hours.

18. The preparation method of claim 13, wherein the thermal treatment of step e) further includes the sub-steps of cooling the sintered green compact, and then annealing the sintered compact at a temperature in the range of 800° C. to 900° C. for 2 to 4 hours and then at a temperature in the range of 450° C. to 550° C. for 3 to 6 hours.

19. The preparation method of claim 14, wherein the thermal treatment of step e) further includes the sub-steps of cooling the sintered green compact, and then annealing the sintered compact at a temperature in the range of 800° C. to 900° C. for 2 to 4 hours and then at a temperature in the range of 450° C. to 550° C. for 3 to 6 hours.

20. The preparation method of claim 15, wherein the thermal treatment of step e) further includes the sub-steps of cooling the sintered green compact, and then annealing the sintered compact at a temperature in the range of 800° C. to 900° C. for 2 to 4 hours and then at a temperature in the range of 450° C. to 550° C. for 3 to 6 hours.
